(19) United States
(12) Patent Application Publication
(10) Pub. No.: US 2024/0237822 A1
(43) Pub. Date: Jul. 18, 2024

(54) SHELF FITTING FOR FURNITURE ARRANGEMENT

(71) Applicant: Häfele Berlin GmbH & Co KG, Berlin (DE)

(72) Inventors: Gerd Sawatzki, Datteln (DE); Robert Birkner, Berlin (DE)

(73) Assignee: Häfele Berlin GmbH & Co KG, Berlin (DE)

(21) Appl. No.: 18/620,855

(22) Filed: Mar. 28, 2024

Related U.S. Application Data
(63) Continuation of application No. PCT/EP22/77054, filed on Sep. 28, 2022.

(30) Foreign Application Priority Data
Sep. 29, 2021 (DE) 20 2021 105 237.6

(51) Int. Cl. A47B 96/06; F16B 12/26

(52) U.S. Cl. CPC A47B 96/066; F16B 12/26

(57) ABSTRACT

A fitting for connecting two parts includes a first and a second fitting part. The first fitting part has a first installation body and with a slider movably guided in the first installation body and can be moved against the action of a restoring force from a starting position. A front slider end protrudes out of the first installation body into a position in which the front slider end does not protrude out of the first installation body. The front slider end has a locking projection which extends transversely to the sliding direction in a direction. The second fitting part is in the form of a second installation body. The second installation body has an opening configured for inserting the front slider end and has an undercut, which is engaged from behind by the locking projection when the front slider end is inserted into the opening.

### CROSS-REFERENCE TO RELATED APPLICATIONS

This continuation application claims priority to PCT/EP2022/077054 filed on Sep. 28, 2022 which has published as WO 2023/052472 A1 and also the German application number 20 2021 105 237.6 filed on Sep. 29, 2021, the entire contents of which are fully incorporated herein with these references.

### DESCRIPTION

### Field of the Invention

The invention relates to a fitting, in particular, a shelf fitting, for connecting two parts, in particular, two furniture parts, e.g., a shelf to a side wall, and an associated assembly comprising two parts which are connected to one another by means of the fitting.

### Background of the Invention

Such fittings are sufficiently well known.

Given the above, the object on which the present invention is based is that of specifying a fitting for connecting two parts, which is of as simple as possible construction.

### SUMMARY OF THE INVENTION

According to the invention, this object is achieved by a fitting for connecting two parts, in particular two furniture parts, comprising: a first fitting part with a first installation body for mounting on a first part to be connected, and with a slider, which is movably guided in the first installation body and can be moved against the action of a restoring force from a starting position, in which a front slider end protrudes out of the first installation body, into a position in which the front slider end protrudes less far or does not protrude out of the first installation body, wherein the front slider end has a locking projection, which extends transversely to the sliding direction in a (transverse) direction; and a second fitting part in the form of a second installation body for mounting on a second part to be connected, wherein the second installation body has an opening, which is configured for inserting the front slider end and has an undercut, which can be engaged from behind by the locking projection when the front slider end is inserted into the opening.

The fitting according to the invention forms an invisible resilient locking system.

The restoring force can be provided, for example, by a spring, in particular a compression spring, which is supported both on the first installation body and on the slider.

In a preferred embodiment, the front slider end has, on its side facing away from the locking projection, an oblique surface which is directed away from the locking projection and slopes both relative to the sliding direction and relative to the transverse direction. The second installation body has an opening base, which is situated opposite the opening and, on its side facing the undercut, has a parallel base portion, which runs parallel to the opening and the distance of which from the undercut corresponds to the thickness of the locking projection. On its side facing away from the undercut, the opening base can have an oblique base portion, which slopes relative to the parallel base portion in a direction toward the undercut and interacts with the oblique surface of the front slider end.

As a particularly preferred option, the locking projection and the second installation body have latching elements, which are latched together when the front slider end is engaged from behind by the locking projection. For example, the locking projection can have latching elements on its rear side facing the first installation body, and the undercut can have latching elements on its inside, said latching elements interacting with one another and comprising, for example, a latching projection and a latching recess. As an alternative, the locking projection can have a latching element on its front side facing away from the first installation body, and the second installation body can have a latching element interacting therewith.

In another preferred embodiment, the opening of the second installation body has a keyhole with an insertion opening for inserting the front slider end and with a slotted opening, which adjoins the insertion opening and which is constricted in comparison with the insertion opening, for engaging behind the undercut of the front slider end. The front side of the second installation body preferably has, on the side of the keyhole facing away from the slotted opening, an additional opening, which opens into the insertion opening and has an oblique opening base, whose depth in relation to the front side, when viewed in the direction away from the insertion opening, decreases continuously to the level of the front side, for movement of the slider into the rear end position against the action of the restoring force. In this case, the depth of the oblique opening base at the insertion opening preferably corresponds at least to the sum of the distance of the end face from the undercut of the front slider end and the thickness of an opening wall, defining the slotted opening, of the second installation body.

The invention also relates to an assembly, in particular a furniture assembly, comprising two parts and a fitting designed as above, wherein the first fitting part is mounted on the one, first part, and the second fitting part is mounted on the other, second part, and wherein the front slider end of the first fitting part is inserted into the opening and engages behind the undercut by means of the locking projection.

The first fitting part is preferably mounted by means of its first installation body in a hole, in particular an elongated hole, in the first part, and the second fitting part is mounted by means of its second installation body in a hole, in particular an elongated hole, in the second part. The front sides of the two installation bodies each end flush with the two parts and rest against each other.

As a particular preference, a latching element arranged on the rear side of the locking projection and a latching element arranged on the inside of the undercut are latched together.

Further advantages of the invention will become apparent from the description, the claims and the drawing. The features mentioned above and those presented below can likewise be used individually or together in any desired combinations. The embodiments shown and described should not be understood as an exclusive enumeration; on the contrary they are of an illustrative character intended to describe the invention.

### BRIEF DESCRIPTION OF THE DRAWINGS

In the drawings:

FIGS. 1a, 1b show two different exploded views of the fitting according to the invention, which is formed from two fitting parts;

FIGS. 2a, 2b show two furniture parts to be connected to one another by means of the fitting according to the invention;

FIGS. 3a-3e show the assembly steps for connecting the two furniture parts shown in FIG. 2 by means of the fitting according to the invention;

FIG. 4 shows a second embodiment of a fitting according to the invention formed from two fitting parts;

FIGS. 5a, 5b show the one, first fitting part of the second embodiment in a perspective view (FIG. 5a) with the upper housing half removed and in an exploded view (FIG. 5b);

FIGS. 6a, 6b show the other, second fitting part of the second embodiment in a longitudinal section (FIG. 6a) and in a front view (FIG. 6b);

FIGS. 7a-7e show the mode of operation of the fitting according to the invention in the second embodiment, in each case in a longitudinal section; and

FIGS. 8a-8e show the assembly steps for connecting two furniture parts by means of the fitting according to the invention in the second embodiment.

### DETAILED DESCRIPTION OF EMBODIMENTS OF THE INVENTION

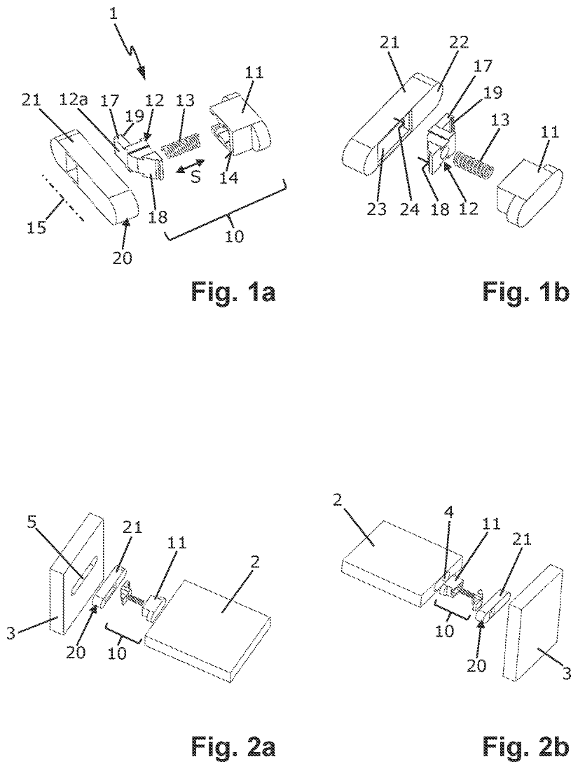

The fitting 1 shown in FIGS. 1a, 1b is used to connect two furniture parts, in this case a shelf 2, to a side wall 3 (FIGS. 2a, 2b), and has two fitting parts 10, 20.

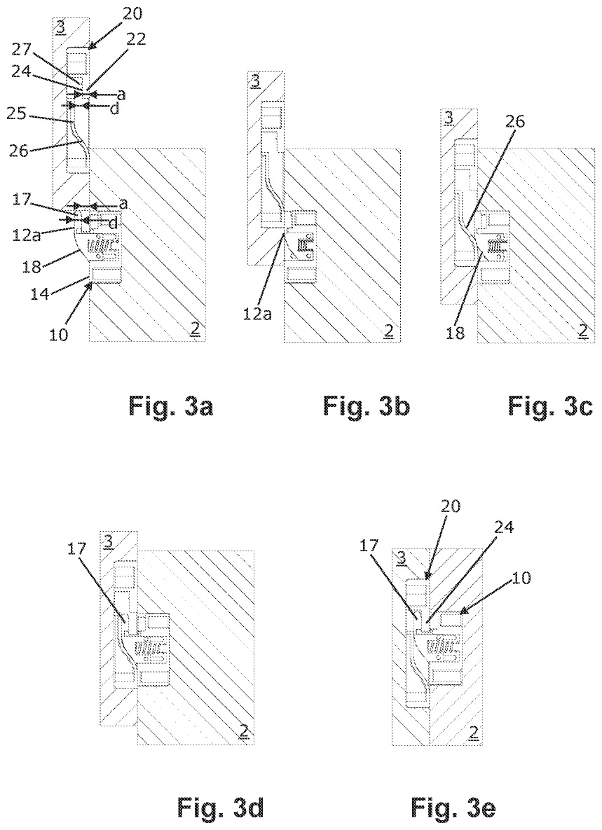

The first fitting part 10 has a first installation body (shelf housing) 11, a slider 12, which is guided in such a way as to be movable in a straight line therein, and a compression spring 13, which is supported at one end on the first installation body 11 and at the other end on the slider 12. The slider 12 can be moved against the action of the compression spring 13 from a starting position shown in FIG. 3a, in which a front slider end 12a protrudes out of the first installation body 11, into a position in which the front slider end 12a protrudes less far out of the first installation body 11. The front slider end 12a can preferably be moved into the first installation body 11 as far as a position in which it is flush with a front side 14 of the first installation body 11. The slider 12 is guided movably in the first installation body 11, e.g. by means of a dovetail guide, wherein inner stops in the first installation body 11 prevent the slider 12 from sliding out of the first installation body 11.

The front slider end 12a has a locking projection 17, which extends transversely, in this case at right angles, to the sliding direction S of the slider 12 in a (transverse) direction 15, and has an oblique surface 18 on the side facing away from the locking projection 17. This oblique surface 18 is directed away from the locking projection 17 and slopes both relative to the sliding direction 16 and relative to the transverse direction 15, in this case by about 45°. On its rear side, which faces the first installation body 11, the locking projection 17 has a latching element 19, here in the form of a latching recess.

The second fitting part 20 is a second installation body (side housing) 21 having a front wall 22, which has an opening 23 for the insertion of the front slider end 12a. The opening 23 has an undercut 24 formed by the front wall 22. The second installation body 21 has an opening base, which is situated opposite the opening 23 and, on its side facing the undercut 24, has a parallel base portion 25, which runs parallel to the front wall 22 or the opening 23 (FIG. 3a) and the distance of which from the undercut 24 corresponds to the thickness d of the locking projection 17. The opening base has, on its side facing away from the undercut 24, an oblique base portion 26 (FIG. 3a), which slopes relative to the parallel base portion 25 in a direction toward the undercut 24, in this case by about 45°. On its inside, the undercut 24 has a latching element 27, here in the form of a latching projection. In the starting position of the slider 12, the distance between the locking projection 17 and the front side 14 of the first installation body 11 corresponds to the wall thickness a of the front wall 22, forming the undercut 24, of the second installation body 21.

As shown in FIGS. 2a, 2b, the first fitting part 10 is mounted by means of its first installation body 11 in a horizontal elongate drilled or milled hole 4 in the end of the shelf 2, and the second fitting part 20 is mounted by means of its second installation body 21 in a horizontal elongate drilled or milled hole 5 in the side wall 3. The front side 14 of the first installation body 11 preferably ends flush with the shelf 2, and the front side 22 of the second installation body 21 ends flush with the side wall 3.

FIGS. 3a-3e show the individual assembly steps for connecting the shelf 2 to the side wall 3 by means of the fitting 1, in each case in a horizontal longitudinal section through the shelf 2 and the side wall 3.

The horizontal shelf 2 is inserted from the front between two side walls 3 until the front end of the locking projection 17 rests against the side wall 3 (FIG. 3a).

The slider 12 is inserted manually into the first installation body 11, and the shelf 2 is then pushed further back in the transverse direction 15 (FIG. 3b).

Owing to the spring force of the compression spring 13, the front slider end 12a is pushed across the oblique surface 18 and the oblique base portion 26, which both slide upon one another, into the opening 23 in the second installation body 21 (FIG. 3c) until the front slider end 12a is resting against the parallel base portion 25 and the front sides 14, 22 of the two installation bodies 11, 21 are resting against one another (FIG. 3d). The slider 12 has now reached its end position.

The shelf 2 continues to be pushed rearward until the shelf 32 ends flush with the side wall 3 at the rear. As a result, the locking projection 17 engages behind the undercut 24 and rests against the parallel base portion 25, on the one hand, and against the undercut 24, on the other hand. In addition, the latching elements 19, 27 of the locking projection 17 and of the undercut 24 are latched together (FIG. 3e). As shown in FIG. 3e, the shelf 32 can also end flush with the side wall 3 at the front.

The disassembly process takes place correspondingly in reverse with respect to the assembly process described.

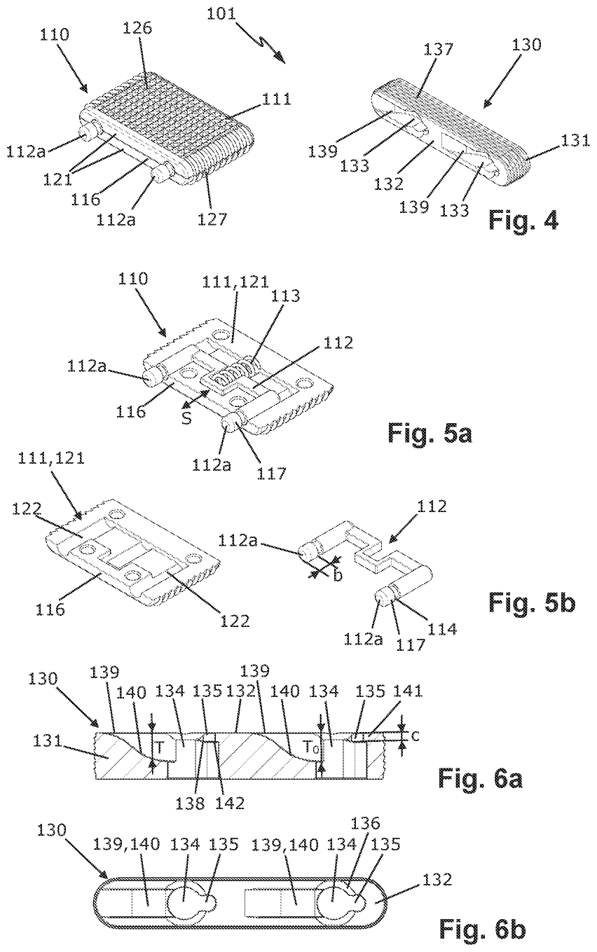

The shelf fitting 101 shown in FIGS. 4-6 differs from the shelf fitting 1 in FIGS. 1-3 in that, in the case of the first fitting part 110, the slider 112 is of fork-shaped design with two locking projections 117, which project transversely, in this case at right angles, to the sliding direction S of the slider 112 and are formed by two front slider ends 112a, in this case pin-shaped slider ends, each having an undercut 114, and in that, in the case of the second fitting part 130, the second installation body 131 has two front-side openings, which are spaced apart in the direction of the width of the front side 132 and are each designed as keyholes 133. The undercut 114 can be an offset in the locking projection and, as shown, can be formed by an annular groove, for example.

The keyholes 133 each have an insertion opening 134, in this case a round insertion opening, for inserting the front slider end 112a, and a slotted opening 135, which adjoins the insertion opening 134 in the direction of the width, on the right in FIG. 6b, and which is constricted in comparison with the insertion opening 134, for engaging behind the undercut 114 of the locking projection 117. A chamfer 136 on the insertion opening 134 makes it easier to insert the front slider end 112a. An additional opening 139 in each case opens into the insertion opening 134 on the side of the keyhole 133 which faces away from the slotted opening 135. The additional opening 139 has an oblique opening base 140, whose depth T in relation to the front side 132, when viewed in the direction away from the insertion opening 134, decreases continuously to the level of the front side 132. The depth T₀ at the insertion opening 134 corresponds at least to an entry depth of the front slider end 112a, which is defined by the sum of the distance b of the end face from the undercut 114 of the front slider end 112a and the thickness c of the opening wall 141, defining the slotted opening 135 and an undercut 142, of the second installation body 131, i.e. T₀≥a+d.

The first installation body 111 can optionally be formed by two housing halves 121, in particular of identical construction, which each have on the inside a guide recess 122 for the slider 112. As a further option, the first installation body 111 can have external projections 126 and external transverse ribs 127.

Along the slotted opening 135, the opening wall 141 of the second installation body 131 optionally has an obliquely rearward-extending tightening contour 138 for the undercut 114 of the front slider end 112a in order to pull the first and the second fitting part 110, 130 into mutual contact. As a further option, the second installation body 131 can have external transverse ribs 137.

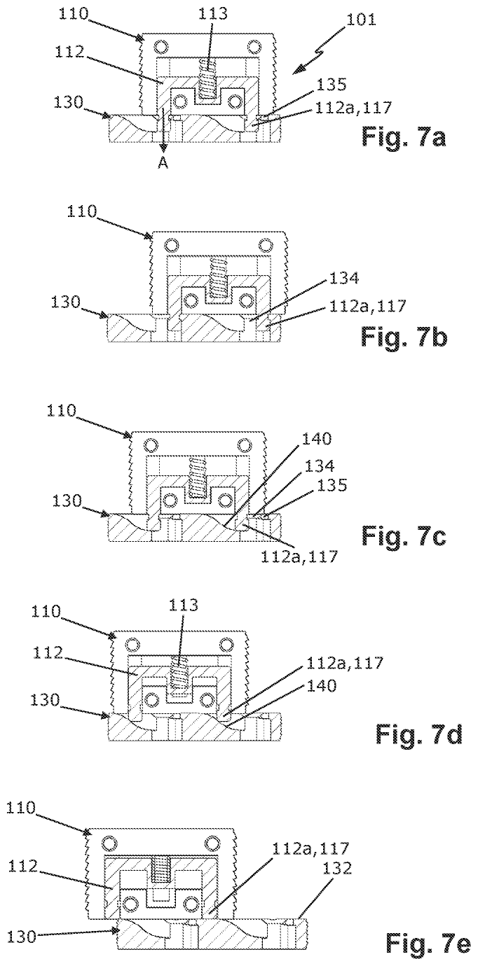

FIGS. 7a-7e show the mode of operation of the shelf fitting 101.

In FIG. 7a, the two fitting parts 110, 130 rest against one another by means of their front sides 116, 132, and the first fitting part 110 has been moved transversely relative to the second fitting part 130 until the front slider ends 112a, driven by the compression spring 113, have entered the insertion openings 134 in insertion direction 117a.

In FIG. 7b, the first fitting part 110 has been moved transversely to the right relative to the second fitting part 130 until the undercuts 114 of the inserted locking projections 117 have each entered the slotted opening 135 and engage behind the opening wall 141 in insertion direction A. As a result, the first fitting part 110 is locked on the second fitting part 130 counter to the insertion direction 117a.

For disassembly, the first fitting part 110 is moved transversely to the left relative to the second fitting part 130 until the front slider ends 112a have emerged from the slotted opening 135 and have been pushed beyond the insertion openings 134 and meet the oblique opening base 140 (FIG. 7c).

When the first fitting part 110 is moved further transversely to the left, the front slider ends 112a are then pushed back on the oblique opening base 140—as is therefore also the slider 112—against the force of the compression spring 113 (FIG. 7d) until, finally, they rest against the front side 132 in the rear slider position (FIG. 7e).

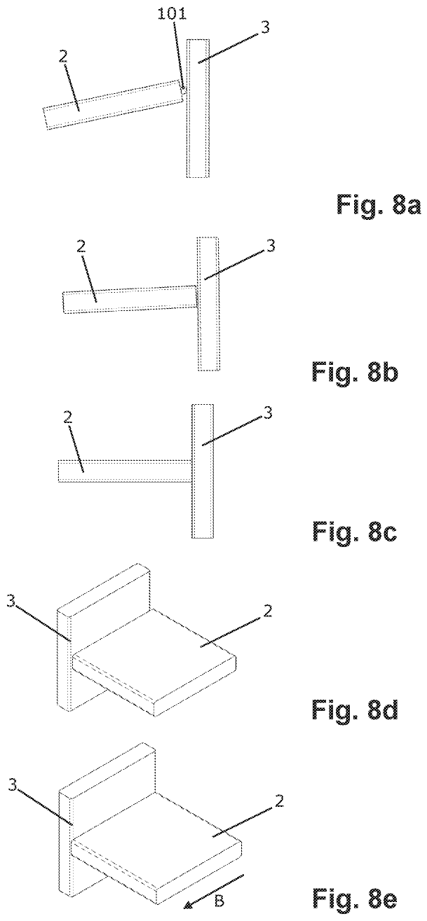

FIGS. 8a-8e show the individual assembly steps for connecting the shelf 2 to the side wall 3 by means of the shelf fitting 101.

The shelf 2 is first of all inserted in a tilted orientation between two vertical side walls 3 (FIG. 8a), and is then aligned in the horizontal position, as a result of which the front slider ends 112a are pushed back into their rear position by the side wall 3 against the action of the compression spring 113 (FIG. 8b). The shelf 2 is moved transversely in the vertical and the depth direction until the front slider ends 112a, driven by the compression spring 113, enter the insertion openings 134 (FIGS. 8c, 8d). The shelf 2 is pushed further rearward relative to the side wall 3 (arrow direction B) until the front slider ends 112a have each entered the slotted opening 135, and locking projections 117 engage by means of their undercut 114 behind the opening wall 141 in insertion direction 117a (FIG. 8e). The shelf fitting 101 allows assembly and disassembly without tools, wherein the installed shelf fitting 101 is invisible.

What is claimed is:

1. A fitting configured for connecting two parts, comprising:
a first fitting part with a first installation body configured for mounting on a first part to be connected, and with a slider, which is movably guided in the first installation body and configured to be moved against the action of a restoring force from a starting position, in which at least one front slider end protrudes out of the first installation body, into a position in which the front slider end protrudes less far or does not protrude out of the first installation body, wherein the front slider end has a locking projection, which extends transversely to a sliding direction in a transverse direction; and
a second fitting part in the form of a second installation body configured for mounting on a second part to be connected, wherein the second installation body has an opening, which is configured for inserting the front slider end and has an undercut, which is engaged from behind by the locking projection when the front slider end is inserted into the opening.

2. The fitting as claimed in claim 1, wherein the restoring force is provided by a spring, which is supported both on the first installation body and on the slider.

3. The fitting as claimed in claim 1, wherein the front slider end has, on its side facing away from the locking projection, an oblique surface which is directed away from the locking projection and slopes both relative to the sliding direction and relative to the transverse direction.

4. The fitting as claimed in claim 1, wherein the slider is guided movably in the first installation body by means of a dovetail guide.

5. The fitting as claimed in claim 1, wherein the locking projection and the second installation body have respective latching elements, which are latched together when the front slider end is engaged from behind by the locking projection.

6. The fitting as claimed in claim 1, wherein the distance between the locking projection and the front side of the first installation body in the starting position of the slider corresponds at least to a wall thickness of a wall, forming the undercut, of the second installation body, or corresponds precisely to the wall thickness.

7. The fitting as claimed in claim 1, wherein the second installation body has an opening base, which is situated opposite the opening and, on its side facing the undercut, has a parallel base portion, which runs parallel to the opening and the distance of which from the undercut corresponds to the thickness of the locking projection.

8. The fitting as claimed in claim 7, wherein the opening base has, on its side facing away from the undercut, an oblique base portion, which slopes relative to the parallel base portion in a direction toward the undercut.

9. The fitting as claimed in claim 1, wherein the opening has a keyhole with an insertion opening for inserting the front slider end and with a slotted opening, which adjoins the insertion opening and which is constricted in comparison with the insertion opening, for engaging behind the undercut of the front slider end.

10. The fitting as claimed in claim 9, wherein the front side of the second installation body has, on the side of the keyhole facing away from the slotted opening, an additional opening, which opens into the insertion opening and has an oblique opening base, whose depth in relation to the front side, when viewed in the direction away from the insertion opening, decreases continuously to the level of the front side, for movement of the slider into the rear end position against the action of the restoring force.

11. The fitting as claimed in claim 10, wherein the depth of the oblique opening base at the insertion opening corresponds at least to the sum of the distance of the end face from the undercut of the front slider end and the thickness of an opening wall, defining the slotted opening, of the second installation body.

12. The fitting as claimed in claim 1, wherein the slider can be moved into the first installation body as far as a position in which it is flush with a front side of the first installation body.

13. An assembly comprising two parts and the fitting as claimed in claim 1, wherein the first fitting part is mounted on the one, first part, and the second fitting part is mounted on the other, second part, and wherein the front slider end is inserted into the opening and engages behind the undercut by means of the locking projection.

14. The assembly as claimed in claim 13, wherein the first fitting part engages by means of its first installation body in a recess in the first part, and the second fitting part is mounted by means of its second installation body in a recess in the second part.

15. The assembly as claimed in claim 13, wherein a latching element arranged on the rear side of the locking projection and a latching element arranged on the inside of the undercut are latched together.

16. The assembly as claimed in any of claims 13, wherein the front side of the first installation body ends flush with the first part, and the front side of the second installation body ends flush with the second part.

17. The assembly as claimed in any of claims 13, wherein the front side of the first installation body and the front side of the second installation body rest against one another.

18. A fitting for connecting two parts, comprising:
a first fitting part with a first installation body configured for mounting on a first part to be connected, and with a slider, which is movably guided in the first installation body and configured to be moved against the action of a restoring force from a starting position, in which at least one front slider end protrudes out of the first installation body, into a position in which the front slider end protrudes less far or does not protrude out of the first installation body, wherein the front slider end has a locking projection, which extends transversely to the sliding direction in a transverse direction; and
a second fitting part in the form of a second installation body configured for mounting on a second part to be connected, wherein the second installation body has an opening, which is configured for inserting the front slider end and has an undercut, which is engaged from behind by the locking projection when the front slider end is inserted into the opening;
wherein the second installation body has an opening base, which is situated opposite the opening and, on its side facing the undercut, has a parallel base portion, which runs parallel to the opening and the distance of which from the undercut corresponds to the thickness of the locking projection.

19. A fitting for connecting two parts, comprising:
a first fitting part with a first installation body configured for mounting on a first part to be connected, and with a slider, which is movably guided in the first installation body and configured to be moved against the action of a restoring force from a starting position, in which at least one front slider end protrudes out of the first installation body, into a position in which the front slider end protrudes less far or does not protrude out of the first installation body, wherein the front slider end has a locking projection, which extends transversely to the sliding direction in a transverse direction; and
a second fitting part in the form of a second installation body configured for mounting on a second part to be connected, wherein the second installation body has an opening, which is configured for inserting the front slider end and has an undercut, which is engaged from behind by the locking projection when the front slider end is inserted into the opening;
wherein the opening has a keyhole with an insertion opening for inserting the front slider end and with a slotted opening, which adjoins the insertion opening and which is constricted in comparison with the insertion opening, for engaging behind the undercut of the front slider end; and
wherein the front side of the second installation body has, on the side of the keyhole facing away from the slotted opening, an additional opening, which opens into the insertion opening and has an oblique opening base, whose depth in relation to the front side, when viewed in the direction away from the insertion opening, decreases continuously to the level of the front side, for movement of the slider into the rear end position against the action of the restoring force.
